(19) United States
(12) Patent Application Publication
(10) Pub. No.: US 2012/0313956 A1
(43) Pub. Date: Dec. 13, 2012

(54) Method And Apparatus For Generating A User Interface

(75) Inventors: Huanyu ZHOU, Shenzhen City (CN); Xiaoyuan GU, Shenzhen City (CN); Qiang TU, Shenzhen City (CN)

(73) Assignee: TENCENT TECHNOLOGY (SHENZHEN) COMPANY LIMITED, Shenzhen City (CN)

(21) Appl. No.: 13/571,543

(22) Filed: Aug. 10, 2012

Related U.S. Application Data
(63) Continuation of application No. PCT/CN2011/070068, filed on Jan. 7, 2011.

(30) Foreign Application Priority Data
Feb. 11, 2010 (CN) 201010109033.1

(51) Int. Cl. G09G 5/00

(52) U.S. Cl. 345/582; 345/629; 345/589

(57) ABSTRACT

A method and an apparatus for generating a user interface. The method includes: obtaining layers to be drawn and layer styles of the layers to be drawn, retrieving attribute information of each layer to be drawn according to the layer style corresponding to the layer and drawing each layer to be drawn according to the retrieved attribute information to obtain drawn layers; and combining the drawn layers to generate a user interface.

### CROSS-REFERENCE TO RELATED APPLICATIONS

This application is a continuation of International Application No. PCT/CN2011/070068, filed on Jan. 7, 2011. This application claims the benefit and priority of Chinese Patent Application No. 201010109033.1, filed Feb. 11, 2010. The entire disclosures of each of the above applications are incorporated herein by reference.

### FIELD

The present disclosure relates to internet technical field and to a method and an apparatus for generating a user interface.

### BACKGROUND

This section provides background information related to the present disclosure which is not necessarily prior art.

With the development of network techniques and software, more and more users realize functions via various kinds of client end software, e.g. instant messaging software, music box, mailbox, etc, as to the client end software, User Interface (UI) is a window for interacting with a user. Users implement corresponding functions through operating the client end software through the UI. Initial design of the UI tends to provide a program interface for satisfying requirements of most users. However, due to different habits, living environments and levels, one UI cannot meet the requirements of all users. In addition, with the increasing of the number of the users, this problem becomes more and more serious. The design of the UI is in a trend of attracting more users and fitting for personal aesthetic habits. In order to meet the aesthetic habits and requirements of different users, more and more application programs support user-customized UI, i.e. skin-change. For example, as to instant messaging software which depends extremely on user's experience, “skin-change” is a very important function.

In the prior art, an application program stores multiple UIs with different styles in advance for user's selection. When wanting to change the skin, the user selects one UI from the candidate UIs and switches the skin to implement the changing of the skin.

From the above, since interface elements only adopt simple picture resources, the ability to display images is limited and it cannot implement more and more expressions in modern UI design. In addition, styles of the picture resources in one set of skins must remain consistent. Therefore, during the change of the skin, all the pictures must be loaded again. Thus, there are more and more pictures in the UI of the application program. Programmers must design a large number of pictures with regard to the skin package, which increases the cost greatly. Therefore, the UI in the prior art is simplex and the change of the skin is inconvenient.

### SUMMARY

This section provides a general summary of the disclosure, and is not a comprehensive disclosure of its full scope or all of its features.

Various embodiments provide a method and an apparatus for generating a user interface, so as to provide different user interfaces according to a user's requirement.

According to an embodiment, a method for generating a user interface is provided. The method includes:

obtaining layers to be drawn and layer styles of the layers to be drawn;

retrieving attribute information of each layer according to the layer style corresponding to the layer, and drawing the layer to be drawn according to the layer style retrieved to obtain drawn layers; and

combining the drawn layers to generate a user interface.

According to another embodiment, an apparatus for generating a user interface is provided. The apparatus includes:

an obtaining module, adapted to obtain layers to be drawn and layer styles of the layers to be drawn;

a layer generating module, adapted to retrieve attribute information of each layer according to the layer style corresponding to the layer and draw each layer to be drawn according to the attribute information retrieved to obtain drawn layers; and

a user interface generating module, adapted to combine the drawn layers to generate a user interface.

According to still another embodiment, a method for generating a user interface is provided. The user interface includes multiple layers, and the method includes:

drawing a background layer;

drawing a controller layer; and

combining the multiple layers including the background layer and the controller layer to generate the user interface.

The various embodiments enable different layers of the user interface to be generated, and the different layers are overlaid to obtain the final user interface. The user interface may be changed dynamically with the change of the attributes of the layers. Thus, diversification of the user interface is realized and it is easy to change the skin of the user interface.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

In order to make the technical solution in the present invention or the prior art clearer, drawings used in the present invention or the prior art will be described briefly hereinafter. The drawings described herein are for illustrative purposes only of selected embodiments and not all possible implementations, and are not intended to limit the scope of the present disclosure. One skilled in the art would acquire other drawings based on these drawings without an inventive work.

FIG. 1 is a flowchart illustrating a method for generating a user interface according to an embodiment.

FIG. 2 is a schematic diagram illustrating a user interface according to an embodiment.

FIG. 3 is a schematic diagram illustrating multiple layers of the user interface according to an embodiment.

FIG. 4 is a flowchart illustrating a method for generating a user interface according to an embodiment.

FIG. 5(a) is a schematic diagram illustrating a structure of a layer according to an embodiment.

FIG. 5(b) is a schematic diagram illustrating an overlaid structure of multiple layers according to an embodiment.

FIG. 5(c) is a schematic diagram illustrating a user interface consists of multiple overlaid layers according to an embodiment.

FIG. 6 is a schematic diagram illustrating a logical division of layers of the user interface according to an embodiment.

FIG. 7 is a schematic diagram illustrating a structure of layers of the user interface after logical division according to an embodiment.

FIG. 8 is a flowchart illustrating a method for generating a user interface according to an embodiment.

FIG. 9 is a schematic diagram illustrating a structure of a background layer of the user interface according to an embodiment.

FIG. 10 is a schematic diagram illustrating a picture layer in the background layer according to an embodiment.

FIG. 11 is a schematic diagram illustrating a color layer of the background layer according to an embodiment.

FIG. 12 is a schematic diagram illustrating a texture layer according to an embodiment.

FIG. 13 is a schematic diagram illustrating a controller layer according to an embodiment.

FIG. 14 is a schematic diagram illustrating a multiplying template of a mask layer according to an embodiment.

FIG. 15 is a schematic diagram illustrating a blue-light layer of the mask layer according to an embodiment.

FIG. 16 is a schematic diagram illustrating an apparatus for generating a user interface according to an embodiment.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

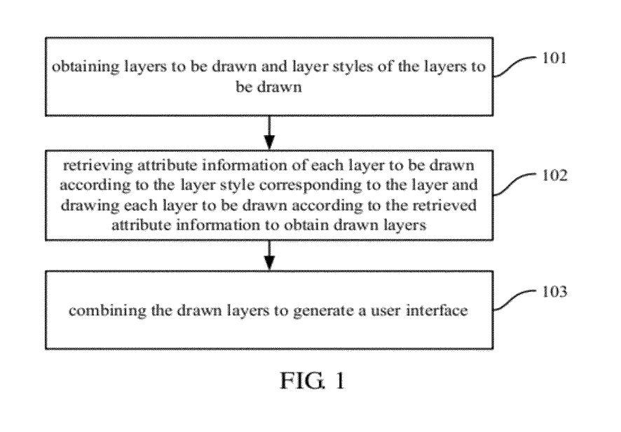

FIG. 1 is a flowchart illustrating a method for generating a user interface according to an embodiment. As shown in FIG. 1, the method includes the following steps.

At 101, layers to be drawn and layer styles of the layers to be drawn are obtained.

At 102, attribute information of the layers is retrieved according to the styles of the layers, and the layers are drawn according to the attribute information retrieved to generate drawn layers.

At 103, the drawn layers are combined to generate a user interface.

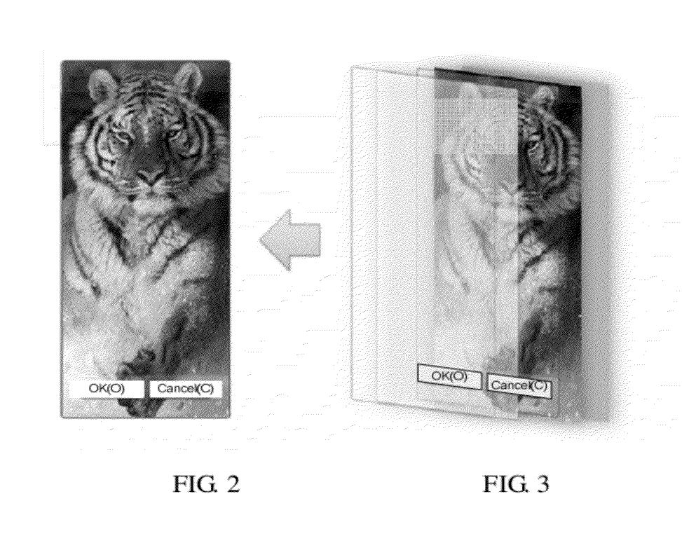

FIG. 2 shows a complete user interface. It can be seen from FIG. 2 that, the user interface includes: a background picture with a tiger and two controllers “OK” and “Cancel” used for interacting with a user.

In order to achieve the above technical solution, an embodiment further provides an apparatus for generating a user interface. In the apparatus, basic units used for generating the user interface are layers. The so-called layers are several drawing layers separated from a complete user interface and each layer forms one layer of the complete user interface. All the layers are finally overlaid and combined to obtain the user interface. Preferably, contents of some layers may be replaced and/or modified selectively. As shown in FIG. 3, through separating the complete user interface shown in FIG. 2, multiple layers can be obtained, e.g., a background layer carrying a tiger picture, a controller layer carrying the controllers “OK” and “Cancel”. In view of this, the key for generating a user interface includes the generation of each layer and the combination of multiple layers. The generation of each layer and the combination of multiple layers may be implemented by configuring layer attributes and overlay of different layers.

Hereinafter, the generation of the basic unit “layer” of the user interface will be described in detail hereinafter.

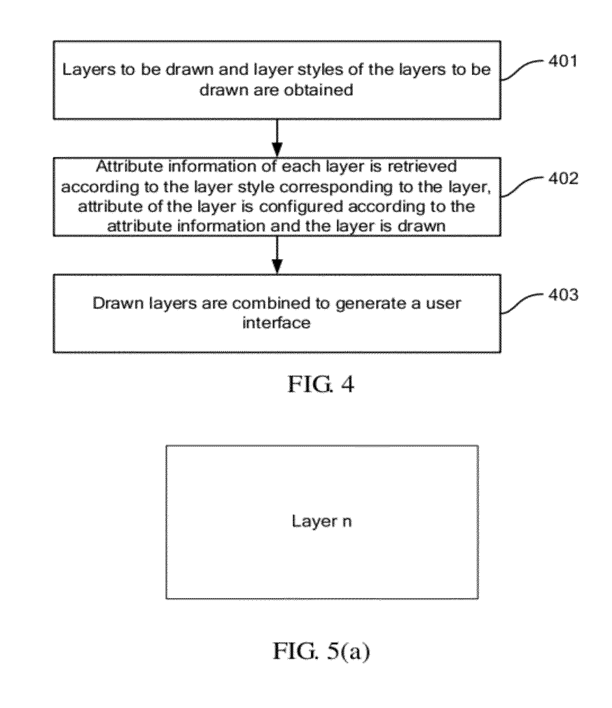

The generation of the layer includes: attribute information of a layer to be drawn is retrieved, the layer to be drawn is configured according to the attribute information and the layer is generated. Specifically, as shown in FIG. 4, the method for generating a user interface includes the following steps.

At 401, layers to be drawn and layer styles of the layers to be drawn are obtained.

The layers are drawing layers separated from a complete user interface. Therefore, during the drawing of the user interface, a complete user interface may be obtained through drawing each layer constituting the user interface and combining multiple layers, wherein the layer style of each layer is style of the corresponding drawing layer.

The user interface is drawn according to a pre-defined style. The user interface consists of multiple layers, wherein each layer carries part of the style of the user interface, i.e. a layer style. Therefore, in order to complete the overall configuration of the user interface, a layer style carried by each layer needs to be obtained.

At 402, attribute information of the layers is retrieved according to the layer styles. The layers to be drawn are drawn according to the retrieved attribute information to obtain drawn layers.

The attributes of the layers mainly include two categories: attributes used for configuring the style of the layer itself and attributes used for overlay with other layers. The attributes generally include: (1) image content attribute; (2) transparency attribute; (3) drawing mode attribute; and (4) mixing mode attribute. Hereinafter, functions of the above attributes will be described in further detail.

(1) Image Content Attribute

The image content attribute, i.e. color data on the layer, forms the image content of the layer through controlling colors on the layer. Preferably, the image content attribute of the layer is obtained by loading a regular picture file (or be designated through configuring specific color data). After the picture file is loaded, the color data and the size of the layer will not change any more.

(2) Transparency Attribute

Since a complete user interface in the embodiment is obtained by overlay and combining multiple layers, an upper layer will cover a lower layer. Therefore, either the need of the layer itself or need of overlay and combining of multiple layers is considered, the transparency attribute of the layer should be configured.

Preferably, the transparency attribute of the layer may be dynamically changed. Certainly, other attributes of the layer may also be changed dynamically. For example, during the running of a program, the transparency attribute may be modified periodically. As such, two layers may disappear or appear little by little.

(3) Drawing Mode Attribute

According to description regarding the image content attribute, after the image content of the layer is selected, the size of the layer will not change, but the size of the user interface formed by the layer is usually adjustable. For example, in a Windows system, the size of a window (i.e. an expression of the user interface) can be adjusted randomly. At this time, how the layer fills up the whole window is determined according to the configuration of this attribute, wherein the drawing mode attribute includes: tile mode, overlaid mode, etc.

(4) Mixing Mode Attribute

When the layers are overlaid, two color data of the overlaid layers need to be mixed. The mixing mode attribute is a mix computing formula for controlling color between two layers. Through the mix computing, color data on everywhere of the overlaid layers is obtained, thus a new color is obtained.

Specifically, the attribute information of the layers is retrieved according to the layer styles. The attributes of the layers to be drawn are configured according to the retrieved attribute information. The generation of a drawn layer includes the following steps.

(1) The attribute information corresponding to the layer is retrieved according to the corresponding layer style.

For example, the drawing mode corresponding to the layer style may be tile, and the corresponding image content may be a designated picture, etc.

(2) The attribute of the layer to be drawn is configured according to the retrieved attribute information and a drawn layer is generated.

Specifically, the retrieval of the attribute information of the layer according to the layer style may include one or more of the following:

(1) Retrieve the picture file to be loaded according to the layer style; obtain the color data according to the picture file, wherein the color data is the image content attribute information of the layer to be drawn.

(2) Retrieve the transparency attribute information of the layer to be drawn according to the layer style and an overlay effect with other layers.

(3) Retrieve the drawing mode attribute information of the layer to be drawn according to the layer style and the window where the layer is located, wherein the drawing mode attribute is used for determining the mode that the layer to be drawn fills up the window.

(4) Retrieve the mixing mode attribute information of the layer to be drawn according to the layer style and a layer style after different layers are overlaid, wherein the mixing mode attribute is used for obtaining the color data of a layer frame of the layer to be drawn.

The drawing the layer according to the attribute information retrieved includes:

(1) Traverse the retrieved attribute information.

(2) If the attribute information is not null, draw the layer to be drawn according to the attribute information.

For example, if the image content of the layer to be drawn is a designated picture, the picture is loaded and color data is retrieved. If the drawing mode of the layer to be drawn is tile, the layer will tile the window if the window of the layer is large but the layer is small during usage.

At 403, the layers are combined to generate the user interface.

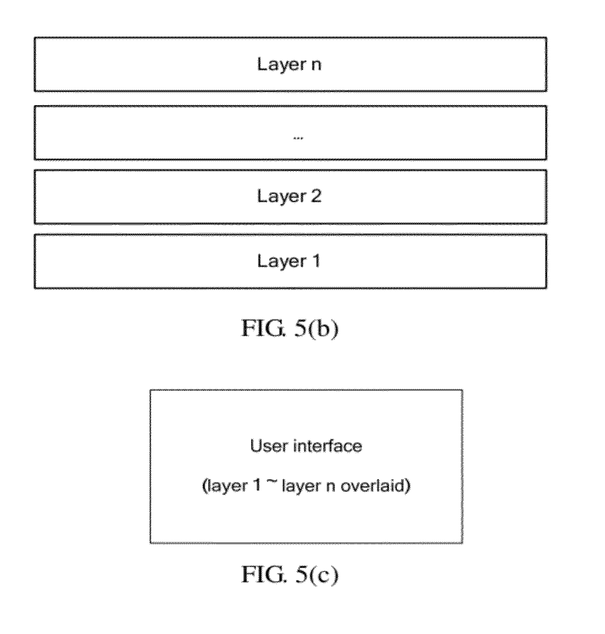

FIG. 5(a) shows a layer, e.g. layer n, according to an embodiment. As shown in FIG. 5(b), n layers are overlaid in order from top to bottom to obtain a complete user interface shown in FIG. 5(c). The user interface consists of layers 1 to n.

It should be noted that, the image result of the several layers may be used as a layer. Therefore, the drawing of the complete user interface is actually a tree structure of multiple layers.

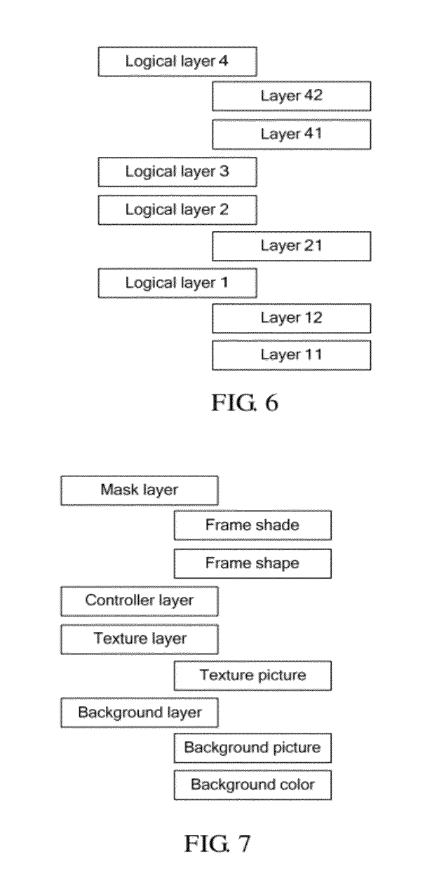

The user interface in FIG. 1 is analyzed. The final user interface consists of multiple expression elements: background image, background color, image frame shape, image frame shade and controller. In order to facilitate the obtaining of any user interface, as shown in FIG. 6, all layers of the user interface are divided into four logical layers. Each logical layer may have multiple layers. The drawing of each layer does not contain special functionality. The logical layer is a result of drawing multiple layers and is given a certain function objective to implement certain function. During the process of generating the user interface, the four logical layers are generated in turn. The four logical layers are overlaid in turn. Then, the final user interface is obtained. As shown in FIG. 7, the four logical layers may be (1) logical layer 1—background layer; (2) logical layer 2—texture layer; (3) logical layer 3—controller layer; and (4) logical layer 4—mask layer.

Hereinafter, each logical layer will be described in further detail with reference to accompanying drawings.

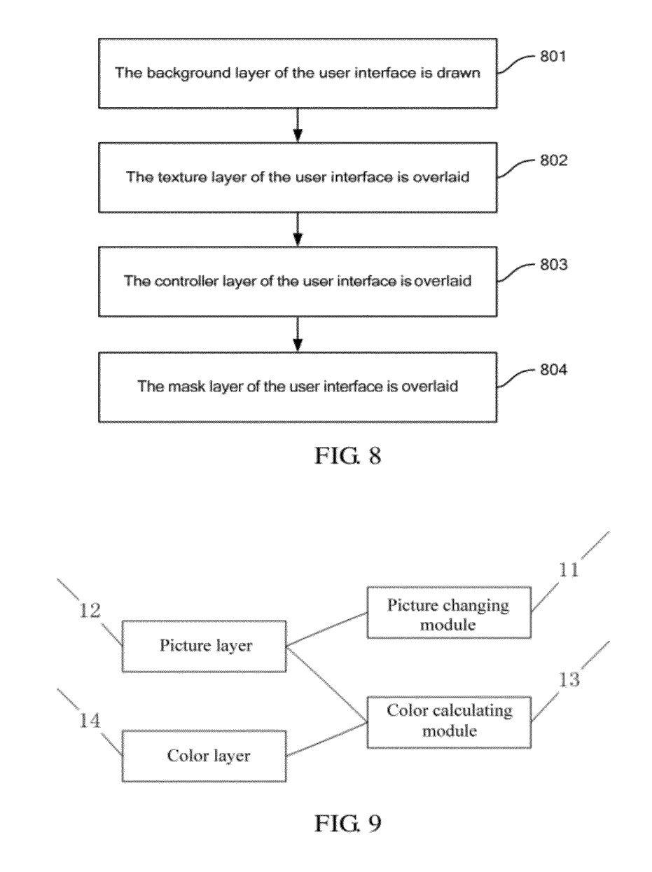

As shown in FIG. 8, according to an embodiment invention, the method for generating a user interface includes the following steps.

At 801, a background layer of the user interface is drawn.

The background layer consists of two layers, respectively, a color layer and a picture layer. The main function of this logical layer is to complete the drawing of the whole background of the user interface (e.g. a Windows window). The background layer is a main visual port of the complete user interface and may be changed according to user's favorite. The color of the color layer in the background layer should be consistent with the whole color of the picture of the picture layer, so as to ensure the visual effect (certainly, it is also possible to designate a color for the color layer). Therefore, the color of the background layer is computed by a program automatically. The computing algorithm is usually the constantly-used octree color quantification algorithm which calculates the most frequently appearing color and obtains an average color close to the whole color.

As shown in FIG. 9, the background layer includes: a picture changing module 11 and a color calculating module 13. When the user initiates a background picture change request, the picture changing module 11 receives the background picture change request and changes the picture according to the user selected picture. After the user changes the picture, the picture changing module 11 informs the picture layer 12 to re-load the picture and read the color data of the loaded picture. After reading the color data, the picture layer 12 transmits the color data to the color calculating module 13. The color calculating module 13 calculates a color which is close to the whole color of the picture and transmits the color to the color layer 14. The color layer 14 stores the color data.

The picture changing module 11 and the color calculating module 13 are not involved in the image drawing process. After being overlaid, the picture layer 12 and the color layer 14 are taken as the main background content of the whole window. Above the background layer is the logical layer expressing other details.

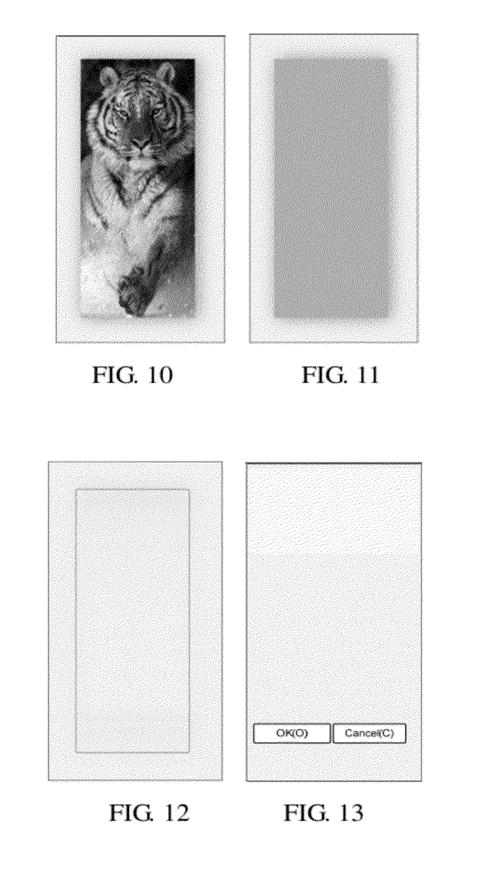

For example, the picture file shown in FIG. 10 is loaded as the picture layer, and the color layer shown in FIG. 11 is obtained according to the picture file.

At 802, the texture layer of the user interface is overlaid.

The texture layer is a layer having a light effect and is overlaid on the background layer. Since the background layer is merely an overlay of the picture and the color, it is a flat picture in the whole drawing area. A regular Windows window consists of a title bar, a customer area, a status bar, etc. The texture layer draws a layer having only light information on the background layer to change the brightness of the background layer. Thus, each logical area of the Windows window may be differentiated on the background layer. The brightness information is determined according to the color data of the image content attribute.

The content of this logical layer does not need the adjustment of the user and thus is fixed.

For example, FIG. 12 shows a texture layer having only brightness information.

At 803, a controller layer of the user interface is overlaid.

Each window has a controller, e.g. Windows button, text box, list box. The controller of the window is drawn in this layer. This layer only needs to retrieve the image content attribute and obtain the pre-defined controller style.

For example, an example controller layer is shown in FIG. 13.

When the controller layer is overlaid on the background layer and the texture layer, the attribute of the controller layer needs to be obtained. The image content and transparency attribute of the background layer and those of the controller layer are mixed.

At 804, the mask layer of the user interface is overlaid.

This logical layer is drawn after other layers are drawn. Therefore, this layer may cover all the controllers of the window. The mask layer is mainly used for providing a frame for the Window and for providing a shading effect for the frame. Accordingly, the mask layer includes a frame shape layer and a frame shade layer.

Hereinafter, the above two functions will be described in detail.

(a) The Frame Shape Layer

Before this layer is drawn, the layer formed by previously drawn layers is generally a rectangle area, e.g., the picture and the background color of the background layer are both exhibited by a rectangle area. However, in a general user interface design, in order to ensure the beauty of the user interface, the edge of the window is usually a rounded angle or an irregular edge. The mask layer is to define a window edge on the previously obtained rectangle layer using an additional layer so as to form the frame of the window. Preferably, according to the mixing mode attribute, the determination of the frame of the window is realized through mixing the attribute information of the additional layer and the previously obtained rectangle layer.

Specifically, the color data and the transparency data of each pixel in the image include four tunnels: a (transparency), r (red), g (green) and b (blue). A mix multiplying formula is as follows:

Dstₐ=Srcₐ*Dstₐ

Dstᵣ=Srcᵣ*Dstᵣ

Dst_{g}=Src_{g}*Dst_{g}

Dst_{b}=Src_{b}*Dst_{b}

Src is a layer adopted for defining the window edge. The content of the layer is a picture with transparency and may be defined by the user interface; Dst is the image content of the layers having been drawn.

In the Src, the portion with pixels are complete transparent (four tunnels a, r, g and b are all 0) has a computed result of complete transparent. The portion with pixels are complete white (four tunnels a, r, g and b are all 1) has a computed result of consistent with previously drawn content. Therefore, a UI designer may control the frame shape of the window by customizing the picture content.

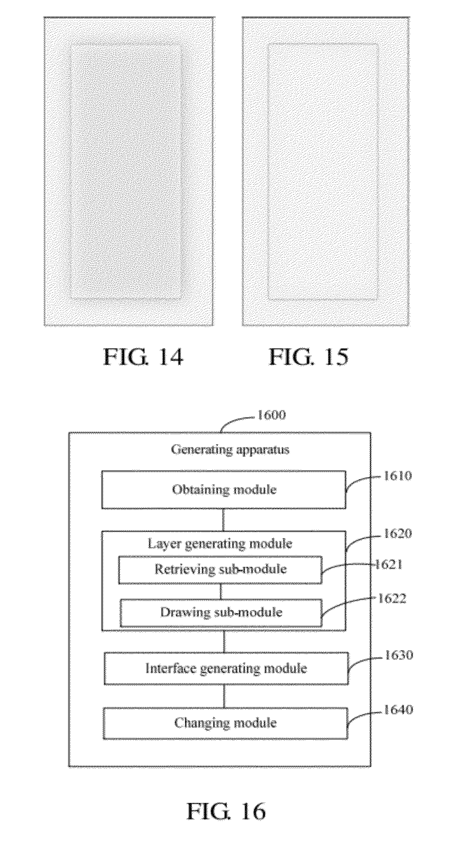

The drawing of the frame of the window may be realized through a template. As shown in FIG. 14, it is a multiplying template of the mask layer.

(b) Frame Shade Layer

In order to realize the transparent shade on the edge of the window, it is only required to add a layer with transparency. The content of the layer may be a picture designed by a UI designer. After the processing of the layers, the drawings of each layer have had a certain edge shape. The shade layer is only required to generate a transparent layer fitting for the edge shape.

For example, as shown in FIG. 15, it is a blue light layer of the mask layer used for generating the shade of the frame of the window.

Finally, after the drawings of the above each layer, the user interface as shown in FIG. 2 is generated.

It should be noted that, the above embodiment merely describes the retrieval of the main attribute information of the layers and the drawing of the layers according to the main attribute information. The attribute of each layer is not restricted not those in the embodiment. All attributes that can be retrieved from the layer styles and used for drawing the layers are included in the protection scope, e.g. audio attribute, etc. In addition, the above logical layers are merely a preferred embodiment. All layers can be separated from the user interface are included in the protection scope, e.g. dynamic effect layer, etc.

According to an embodiment, an apparatus for generating a user interface is provided. The apparatus 1600 includes:

an obtaining module 1610, adapted to obtain layers to be drawn and layer styles of the layers to be drawn;

a layer generating module 1620, adapted to retrieve attribute information of the layers according to the layer styles, draw the layers to be drawn according to the attribute information retrieved to obtain drawn layers; and

an interface generating module 1630, adapted to combine the drawn layers to generate the user interface.

The drawn layers include one or more of the following: a background layer, a texture layer, a controller layer and a mask layer.

The attribute information includes: image content, transparency, drawing mode and mixing mode.

The layer generating module 1620 includes a retrieving sub-module 1621, adapted to:

obtain a picture file required to be loaded according to the layer style, obtain color data according to the picture file, wherein the color data is image content attribute information of the layer to be drawn;

or, retrieve the transparency attribute information of the layer to be drawn according to the layer style and an overlay effect with other layers;

or, retrieve the drawing mode attribute information of the layer to be drawn according to the layer style and the window where the layer is located, wherein the drawing mode attribute is used for determining the mode that the layer to be drawn filling up the window;

or, retrieve the mixing mode attribute information of the layer to be drawn according to the layer style and a layer style after different layers are overlaid, wherein the mixing mode attribute is used for obtaining color data of a frame of the layer to be drawn.

The retrieving sub-module 1621 is adapted to:

obtain first color data of the picture file according to the picture file; and

obtain second color data matching the first color data according to the picture file.

The retrieving sub-module 1621 is adapted to:

obtain a frame shape layer according to a layer style after different layers are overlaid;

obtain color data of the layers having been drawn and color data of the frame shape layer; and

mix the color data of the layers having been drawn and the color data of the frame shape layer according to a color mix multiplying formula to obtain the color data of the frame of the layer to be drawn.

The layer generating module 1620 includes a drawing sub-module 1622, adapted to:

traverse the retrieved attribute information, draw the layer to be draw according to the attribute information if the attribute information is not null.

The interface generating module 1630 is adapted to overlay at least two drawn layers to generate the user interface.

The apparatus further includes:

a changing module 1640, adapted to dynamically change the attribute of the layers having been drawn.

The present disclosure enables generating different layers of the user interface according to the user's requirement, and the layers are overlaid to obtain the final user interface. The user interface may be changed dynamically by changing the attribute of the layers. As such, diversity of the user interface is realized and the user interface is more easily changed. In addition, since the user interface is divided into multiple layers, the visual effect of the whole user interface may be changed by merely changing some of the layers. Furthermore, the user is able to customize the user interface using his/her pictures. The style of the whole user interface may be adjusted automatically according to the user's customization. Therefore, the solution provided by the present disclosure can not only change a skin conveniently but also is not required to store a large amount of pictures in advance.

Based on the above descriptions, one with ordinary skill in the art would recognize that the present embodiments may be implemented by software accompanying with necessary hardware platform. It is also possible to implement the solution by hardware. Based on this, the present embodiments or the contribution part may be expressed by software product in essence. The software may be stored in a machine readable storage medium and includes machine readable instructions executable by a terminal device (e.g. a cell-phone, a personal computer, a server or a network device, etc) to implement the steps of method provided by various embodiments.

What has been described and illustrated herein is an example of the disclosure along with some of its variations. The terms, descriptions and figures used herein are set forth by way of illustration only and are not meant as limitations.

One with ordinary skill in the art would recognize that the modules in the apparatus of the embodiments may be distributed in the apparatus of the embodiment, or may have variations and be distributed in one or more apparatuses. The modules may be integrated as a whole or disposed separately. The modules may be combined into one module or divided into multiple sub-modules.

Many variations are possible within the spirit and scope of the disclosure, which is intended to be defined by the following claims—and their equivalents—in which all terms are meant in their broadest reasonable sense unless otherwise indicated.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for generating a user interface, comprising:
obtaining layers to be drawn and layer styles of the layers to be drawn;
retrieving attribute information of each layer according to the layer style corresponding to the layer, and drawing each layer to be drawn according to the layer style retrieved to obtain drawn layers; and
combining the drawn layers to generate a user interface.

2. The method of claim 1, wherein
the drawn layers comprise one or more of a background layer, a texture layer, a controller layer and a mask layer; and
the attribute information comprises: image content, transparency, drawing mode and mixing mode.

3. The method of claim 2, wherein the retrieving the attribute information of each layer according to the layer style corresponding to the layer comprises one or more of the following:
obtaining a picture file to be loaded according to the layer style, obtaining color data according to the picture file, wherein the color data is image content attribute information of the layer to be drawn;
retrieving transparency attribute information of the layer to be drawn according to the layer style and an overlay effect with other layers;
retrieving drawing mode attribute information of the layer to be drawn according to the layer style and a window where the layer is located, wherein the drawing mode attribute is used for determining a mode that the layer to be drawn filling up the window; and
retrieving mixing mode attribute information of the layer to be drawn according to the layer style and a layer style after different layers are overlaid, wherein the mixing mode attribute is used for obtaining color data of a frame of the layer to be drawn.

4. The method of claim 3, wherein the obtaining the color data of the picture file comprises:
obtaining first color data of the picture file according to the picture file; and
obtaining second color data matching the first color data according to the picture file.

5. The method of claim 1, wherein the drawing the layer to be drawn according to the retrieved attribute information comprises:
traversing the attribute information retrieved; and
if the attribute information is not null, drawing the layer to be drawn according to the attribute information.

6. The method of claim 1, wherein the combining the drawn layers to generate the user interface comprises:
mixing the attribute information of the drawn layers one by one to generate the user interface.

7. The method of claim 1, further comprising:
dynamically changing the attribute of the drawn layers.

8. An apparatus for generating a user interface, comprising:
an obtaining module, adapted to obtain layers to be drawn and layer styles of the layers to be drawn;
a layer generating module, adapted to retrieve attribute information of each layer according to the layer style corresponding to the layer and draw each layer to be drawn according to the attribute information retrieved to obtain drawn layers; and
a user interface generating module, adapted to combine the drawn layers to generate a user interface.

9. The apparatus of claim 8, wherein the drawn layers comprise one or more of a background layer, a texture layer, a controller layer and a mask layer;
the attribute information comprises: image content, transparency, drawing mode and mixing mode.

10. The apparatus of claim 9, wherein the layer generating module comprises a retrieving sub-module, adapted to
obtain a picture file to be loaded according to the layer style, obtain the color data of the picture file, wherein the color data is image content attribute information of the layer to be drawn;
or, retrieve transparency attribute information of the layers to be drawn according to the layer style and an overlay effect with other layers;
or, retrieve the drawing mode attribute information of the layer to be drawn according to the layer style and the window where the layer is located, wherein the drawing mode attribute is used for determining the mode that the layer to be drawn filling up the window;
or, retrieve the mixing mode attribute information of the layer to be drawn according to the layer style and a layer style after different layers are overlaid, wherein the mixing mode attribute is used for obtaining color data of the frame of the layer to be drawn.

11. The apparatus of claim 10, wherein the retrieving sub-module is adapted to
obtain first color data of the picture file according to the picture file; and
obtain second color data matching the first color data according to the picture file.

12. The apparatus of claim 8, wherein the layer generating module comprises a drawing sub-module, adapted to
traverse the retrieved attribute information, and draw the layer to be drawn according to the attribute information if the attribute information is not null.

13. The apparatus of claim 8, wherein the interface generating module is adapted to mix the attribute information of the drawn layers one by one to combine the drawn layers.

14. The apparatus of claim 8, further comprising:
a changing module, adapted to dynamically change the attribute of the drawn layers.

15. A method for generating a user interface, wherein the user interface comprises multiple layers, the method comprises:
drawing a background layer;
drawing a controller layer;
combining the multiple layers comprising the background layer and the controller layer to generate a user interface.

16. The method of claim 15, wherein the background layer comprises a picture layer and a color layer, and the drawing the background layer comprises:
loading a picture to draw the picture layer;
calculating a color appears most frequently in the picture, obtaining an average color closing to a whole color the picture, and draw the color layer using the average color.

17. The method of claim 15, further comprising:
drawing a texture layer on above of the controller layer.

18. The method of claim 15, further comprising:
drawing a mask layer on above of the controller layer.

19. The method of claim 18, wherein the mask layer comprises a frame shape layer and a frame shade layer.

20. The method of claim 15, wherein the combining the multiple layers comprising the background layer and the controller layer to generate a user interface comprises:
mixing attribute information of the multiple layers comprising the background layer and the controller layer one by one to generate the user interface.

21. The method of claim 15, further comprising:
dynamically changing transparency of at least one of the background layer and the controller layer.
